(19) United States
(12) Patent Application Publication
(10) Pub. No.: US 2005/0034286 A1
(43) Pub. Date: Feb. 17, 2005

(54) Container for storage and transportation of dead animals or organic waste

(76) Inventors: Louis Landry, St-Narcisse (CA); Victor Landry, St-Narcisse (CA)

Correspondence Address: Louis Landry, 425 St-Jacques, St-Narcisse, GOS 1WO, CA

(21) Appl. No.: 10/637,113

(22) Filed: Aug. 11, 2003

(51) Int. Cl. A61G 17/00

(52) U.S. Cl. 27/11

(57) ABSTRACT

The present invention provides a container for storage and transportation of dead animals or organic waste, and which prevents their decomposition by the use of a nitrogen storage tank for saturate air.

### BACKGROUND OF THE INVENTION

1. Field of the Invention

The present invention relates to a container for storage and transportation of dead animals or organic waste, and which prevents their decomposition by the use of a nitrogen storage tank for saturate air.

2. Description of the Related Art

A search of prior art records has unveiled the following patents:
1. CA 2,323,919 issued in 2001 to Deng;
2. CA 1,210,374 issued in 1986 to Urban;
3. CA 2,037,928 issued in 1991 to Jost; and
4. CA 2,153,529 issued in 2002 to Buehler.

The patents mentioned above are probably the most relevant.

It is well known to used a truck for transport dead animals or organic waste which are shipped towards an incinerator in order to be burnt.

It is therefore an object of the invention to provide a container for storage and transportation of dead animals or organic waste, and which prevents their decomposition by the use of a nitrogen storage tank for saturate air.

### SUMMARY OF THE INVENTION

Accordingly, one aspect of the present invention consists in a container for storage and transportation of dead animals or organic waste, which includes a structure on which is connected a bulging top provided with a revolving body member formed therein to permit the access of organic waste inside without have need to open the top of the container.

A frame mounted to the structure is formed with a handle member for actuate each upper clipping piece engaging a head pin mounted of each side from top, which are attached to each arm member passing therethrough a triangular part member, and which are connected to each lower connecting piece engaged into a handle member fixed of each side of container.

Each spring connected from each side of the structure is blocked by a cap piece and engaged to a rod mounted of each side from top for keeping the top wide open during the loading of dead animals and unloading of dead animals or organic waste.

A watertightness means is engaged inside the top for closing hermetically the container in order to avoid nitrogen to be exhausted from outside the container.

A swivelling panel is engaged at the rear structure of container and rested against each support member located under the swivelling panel for protecting a control circuit coupled to a valve transfer that is connected to a battery which is coupled to a switch.

Also, the control circuit is coupled to a body member that is feeded by a pipe that is connected to a shutoff valve formed therein a tank which is fixed by each fastening piece to the container.

Furthermore, the body member feeds a pipe passing therethrough an orifice formed into the container, and which a portion of pipe located under each transverse bar, is provided with small holes for let entering an amount of nitrogen into the container.

A plate member provided with a series of holes is mounted over pipe for it preventing to be damaged.

Each pressure valve coupled to the control circuit and connected to the container, enables to free air outside from the interior of the container.

Each blocking piece engaged into each hole formed therethrough container, is pulled out from each hole during the cleaning of container.

A switch is fixed to container and coupled to the battery for cutting off the contact and preventing nitrogen to circulate inside the container when the top of container is lifted up.

### BRIEF DESCRIPTION OF THE SEVERAL VIEWS OF THE DRAWING(S)

FIG. 1 shows a perspective rear view of a container for storage and transportation of dead animals or organic waste, and which prevents their decomposition by the use of a nitrogen storage tank for saturate air;

FIG. 2 shows a perspective front view thereof;

FIG. 3 shows a perspective front view showing the container wide open;

FIG. 4 shows a rear plan view of container;

FIG. 5a shows a side plan view showing the container closed;

FIG. 5b shows a side plan view showing the container wide open; and

FIG. 6 shows an exploded view of container.

### DETAILED DESCRIPTION OF THE PREFERRED EMBODIMENT

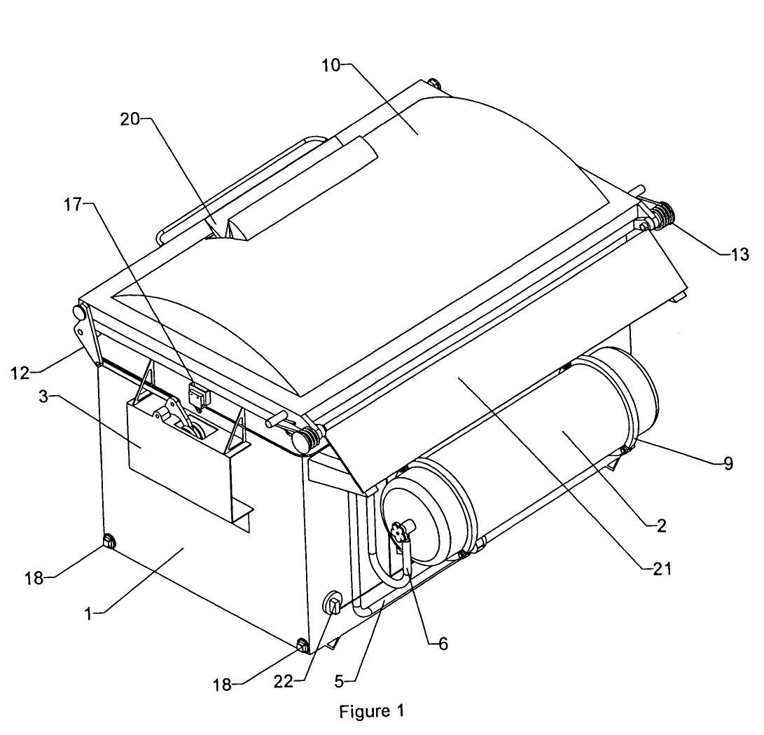

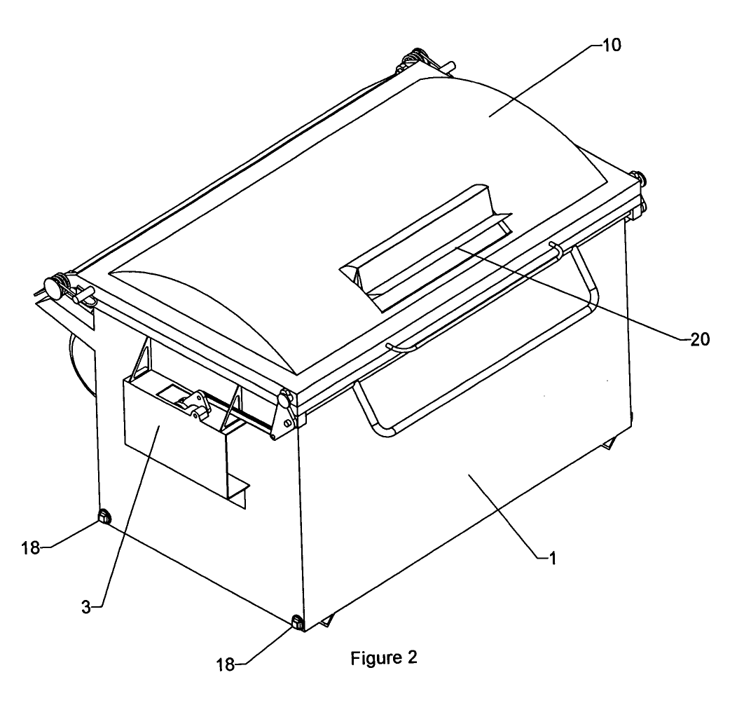

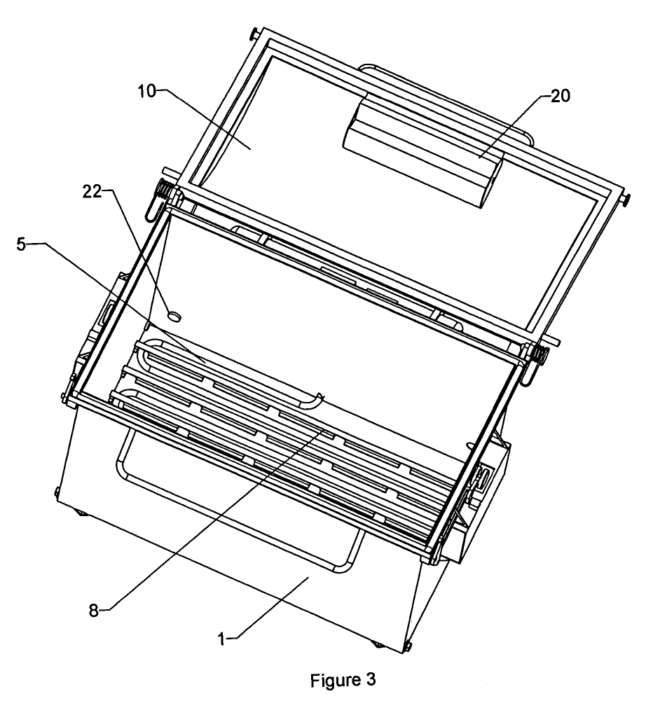

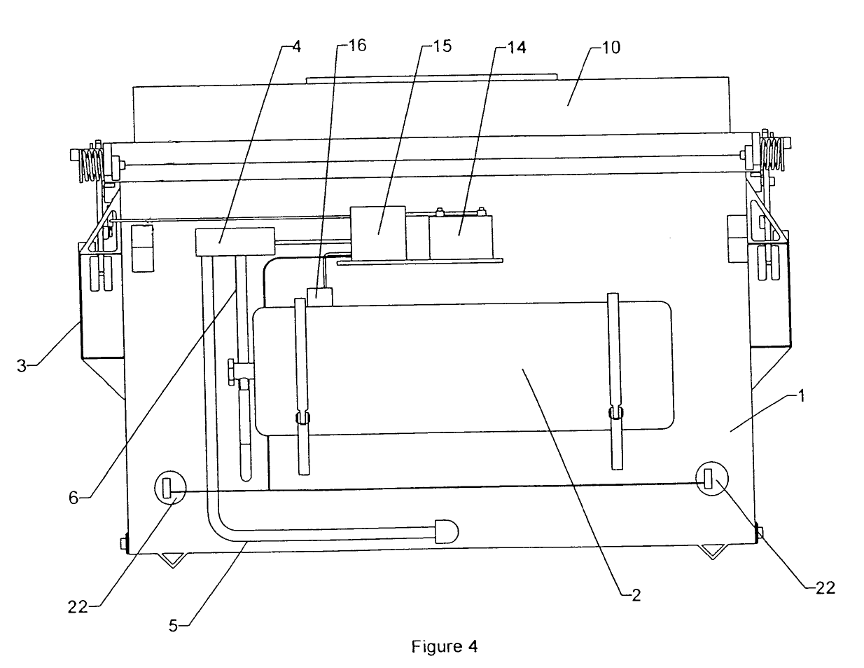

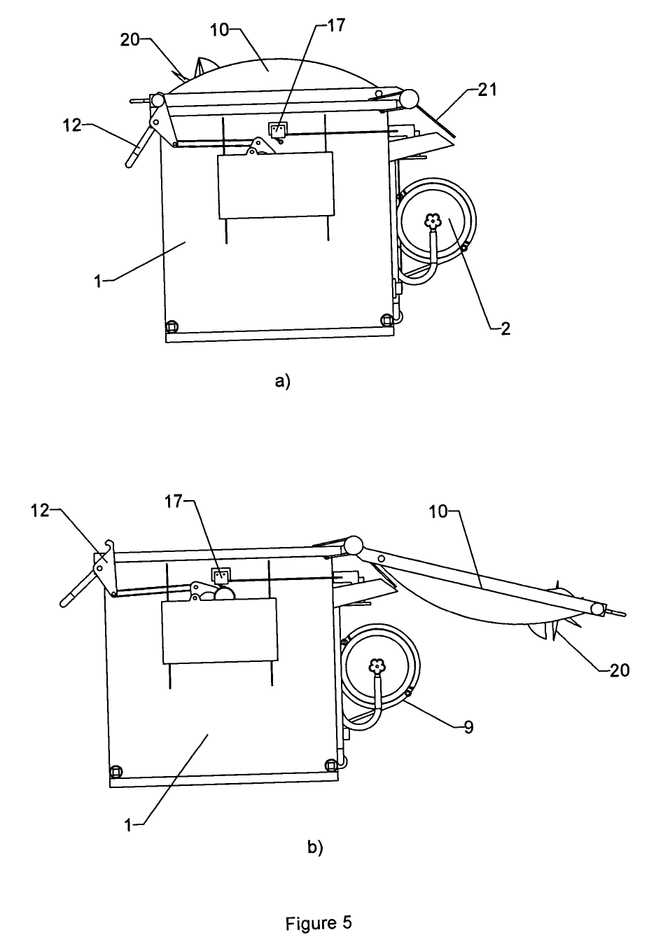

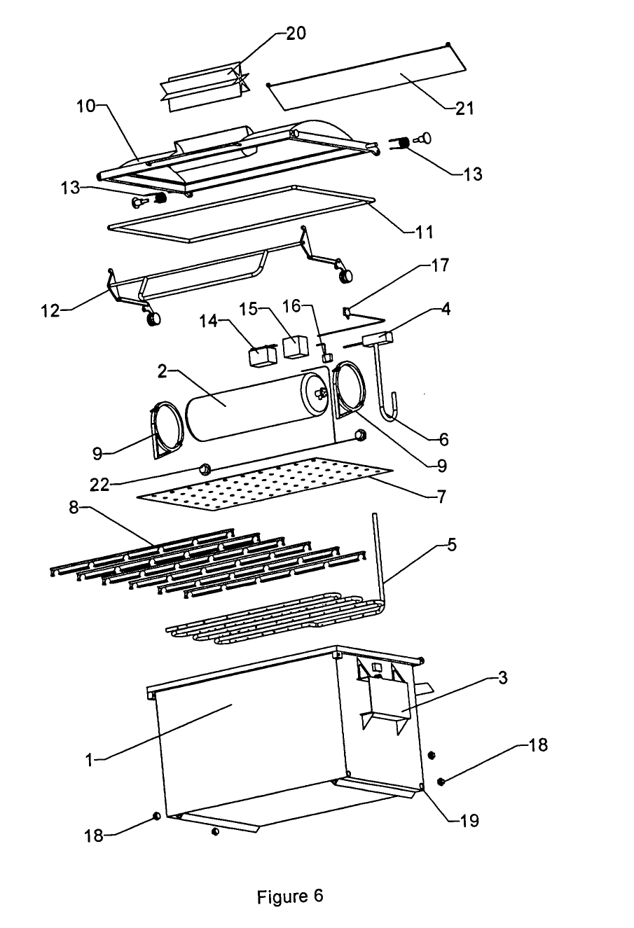

Referring now to FIGS. 1 to 6, there is illustrated a container (1) for storage and transportation of dead animals or organic waste, which includes a structure on which is connected a bulging top (10) provided with a revolving body member (20) formed therein to permit the access of organic waste inside without have need to open the top (10) of the container (1).

A frame (12) mounted to the structure is formed with a handle member for actuate each upper clipping piece engaging a head pin mounted of each side from top (10), which are attached to each arm member passing therethrough a triangular part member, and which are connected to each lower connecting piece engaged into a handle member (3) fixed of each side of container (1).

Each spring (13) connected from each side of the structure is blocked by a cap piece and engaged to a rod mounted of each side from top (10) for keeping the top wide open during the loading of dead animals and unloading of dead animals or organic waste.

A watertightness means (11) is engaged inside the top (10) for closing hermetically the container (1) in order to avoid nitrogen to be exhausted from outside the container (1).

A swivelling panel (21) is engaged at the rear structure of the container (1) and rested against each support member located under the swivelling panel (21) for protecting a control circuit (15) coupled to a valve transfer (16) that is connected to a battery (14) which is coupled to a switch (17).

Also, the control circuit (15) is coupled to a body member (4) that is feeded by a pipe (6) which is connected to a shutoff valve formed therein a tank (2) that is fixed by each fastening piece (9) to the container (1).

Furthermore, the body member (4) feeds a pipe (5) passing therethrough an orifice formed into the container (1), and which a portion of pipe (5) located under each transverse bar (8), is provided with small holes for let entering an amount of nitrogen into the container (1).

A plate member (7) provided with a series of holes is mounted over pipe (5) for it preventing to be damaged.

Each pressure valve (22) coupled to the control circuit (15) and connected to the container (1), enables to free air outside from the interior of the container (1).

Each blocking piece (18) engaged into each hole (19) formed therethrough container, is pulled out from each hole (19) during the cleaning of container (1).

A switch (17) is fixed to container (1) and coupled to the battery (14) for cutting off the contact and preventing nitrogen to circulate inside the container when the top (10) of container (1) is lifted up.

Although only a single embodiment of the present invention has been described and illustrated, the present invention is not limited to the features of this embodiment, but includes all variations and modifications within the scope of claims.

1. A container for storage and transportation of dead animals or organic waste, which comprising:
a structure on which is connected a bulging top provided with a revolving body member formed therein to permit the access of organic waste inside without have need to open the top of the container,
a frame mounted to the structure is formed with a handle member for actuate each upper clipping piece engaging a head pin mounted of each side from top, which are attached to each arm member passing therethrough a triangular part member, and which are connected to each lower connecting piece engaged into a handle member fixed of each side of container,
a means for connecting each spring from each side of the structure, which are blocked by a cap piece and engaged to a rod mounted of each side from top for keeping the top wide open during the loading of dead animals and unloading of dead animals or organic waste;
a watertightness means is engaged inside the top for closing hermetically the container in order to avoid nitrogen to be exhausted from outside the container,
a swivelling panel is engaged at the rear structure of the container and rested against each support member located under the swivelling panel for protecting a control circuit coupled to a valve transfer that is connected to a battery which is coupled to a switch,
the control circuit is also coupled to a body member that is feeded by a pipe which is connected to a shutoff valve formed therein a tank that is fixed by each fastening piece to said container,
said body member feeds a pipe passing therethrough an orifice formed into the container, and which a portion of pipe located under each transverse bar, is provided with small holes for let entering an amount of nitrogen inside the container,
a plate member provided with a series of holes is mounted over said pipe for it preventing to be damaged, a means for coupling each pressure valve to said control circuit connected to said container, which enables to free air outside from the interior of the container,
a means for engaging each blocking piece into each hole formed therethrough said container, and which are pulled out from each hole for cleaning the container, and
a switch is fixed to said container and coupled to said battery for cutting off the contact and preventing nitrogen to circulate inside the container when the top of said container is lifted up.

2. A method of preserving dead animals and organic waste, comprising:
a means for using a nitrogen storage tank replacing air from the interior of the container for preventing the proliferation of bacteria.

3. The container of the claim 1 which is used with a nitrogen storage tank, may be also mounted to a truck.
